(19) United States
(12) Patent Application Publication
(10) Pub. No.: US 2015/0091446 A1
(43) Pub. Date: Apr. 2, 2015

(54) LIGHTING CONTROL CONSOLE AND LIGHTING CONTROL SYSTEM

(71) Applicant: Panasonic Corporation, Osaka (JP)

(72) Inventors: Kenji OHTA, Osaka (JP); Nobuo IWATA, Osaka (JP)

(21) Appl. No.: 14/494,800

(22) Filed: Sep. 24, 2014

(30) Foreign Application Priority Data
Sep. 30, 2013 (JP) 2013-204689

(51) Int. Cl. H05B 37/02

(52) U.S. Cl. CPC H05B 37/0227
USPC 315/153

(57) ABSTRACT

The lighting control console includes a display, an operation device and a controller. The display displays a lighting spatial image corresponding to the lighting space, and displays, in the lighting spatial image, virtual instruments corresponding to the respective lighting instruments so that positions of the virtual instruments in the lighting spatial image correspond to respective positions of the lighting instruments in the lighting space. The operation device has a three dimensional detection space associated with the lighting spatial image and/or the lighting space. The operation device detects a position of an operation object in the detection space and specifies a position in the lighting spatial image based on the detected position in the detection space. The controller identifies, when one of the virtual instruments in the lighting spatial image is specified by the operation object through the operation device, a lighting instrument associated with the specified virtual instrument.

### CROSS-REFERENCE TO RELATED APPLICATIONS

The application is based upon and claims the benefit of priority of Japanese Patent Application No. 2013-204689, filed on Sep. 30, 2013, the entire contents of which are incorporated herein by reference.

### TECHNICAL FIELD

The disclosure relates generally to lighting control consoles and lighting control systems and, more particularly, to a lighting control console and a lighting control system for controlling stage lighting of a theater stage, a broadcasting studio, and the like.

### BACKGROUND ART

JP2012-69423A (hereinafter, referred to as “Document 1”) discloses a lighting control device as a conventional example. This conventional example is configured to take by a camera an image of a stage in which a number of lighting instruments are installed, and to display the image of the stage on a monitor-display with a touch panel. This conventional example enables a user to select a lighting instrument by touching a symbol of the lighting instrument on the display, and to enter control instructions (such as a dimming level, pan/tilt angles, and the like) of the selected lighting instrument through the touch panel, a keyboard, and the like.

According to the conventional example, it is possible to arbitrarily select a target lighting instrument out of a number of lighting instruments by means of the touch panel.

Incidentally, in the conventional example disclosed in Document 1, a position of the stage (a coordinate set in three-dimensional orthogonal coordinate system; e.g., represented as (x, y, z)) is converted into a position of the monitor-display (a coordinate set in two-dimensional orthogonal coordinate system; e.g., represented as (u, v)). It is therefore difficult for a user to recognize a difference in a depth direction of the stage by the two dimensional image of the stage displayed on the display (i.e., by the image of the stage taken by the camera). Therefore, the conventional example has a concern of causing the user to select (touch) a symbol of a lighting instrument displayed on the near side of the stage in an attempt to select (touch) a symbol of a lighting instrument displayed on the back side of the stage.

### SUMMARY

The present invention has been achieved in view of the above circumstances, and an object thereof is to improve the workability of operation such as selecting a lighting instrument, in comparison with the conventional example that uses a touch panel.

A lighting control console according to an aspect of the invention is configured to control lighting instruments installed in a lighting space in order to control stage lighting. The lighting control console includes a display, an operation device, and a controller. The display is configured to display a lighting spatial image corresponding to the lighting space, and to display, in the lighting spatial image, virtual instruments which correspond to the respective lighting instruments so that positions of the virtual instruments in the lighting spatial image correspond to respective positions of the lighting instruments in the lighting space. The operation device has a three dimensional detection space associated with at least one of the lighting spatial image and the lighting space, and is configured to detect a position of an operation object in the detection space and to specify a position in the lighting spatial image based on the detected position in the detection space. The controller is configured, when one of the virtual instruments in the lighting spatial image is specified by the operation object through the operation device, to identify a lighting instrument associated with the specified virtual instrument.

A lighting control system according to an aspect of the invention includes the lighting control console described above and the lighting instruments installed in the lighting space.

According to the lighting control console and the lighting control system, it is possible to improve the workability of operation such as selecting a lighting instrument, in comparison with the conventional example that uses a touch panel.

### BRIEF DESCRIPTION OF THE DRAWINGS

The figures depict one or more implementation in accordance with the present teaching, by way of example only, not by way of limitations. In the figures, like reference numerals refer to the same or similar elements where:

FIG. 1 is a schematic block diagram of a lighting control console according to an embodiment as well as a system configuration diagram of a lighting control system according to an embodiment;

FIG. 2A is a perspective view of the lighting control console according to the embodiment, FIG. 2B is a perspective view of an operation device according to the embodiment, and FIG. 2C is a perspective view of another example of an operation device according to the embodiment;

FIG. 3A is a five orthogonal views of a stage to be displayed on a display according to the embodiment, and FIG. 3B is a perspective view of a stage to be displayed on a display according to the embodiment; and

FIG. 4 is a perspective view of a stage in which lighting instruments controlled by the lighting control console according to the embodiment are installed.

### DETAILED DESCRIPTION

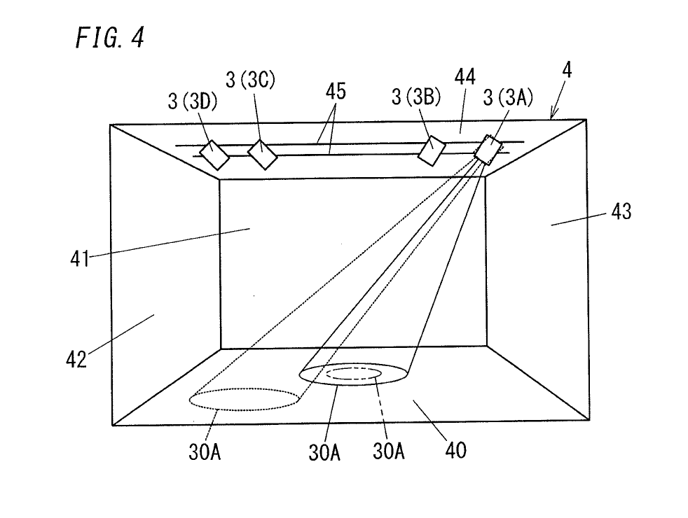

A lighting control console and a lighting control system according to the present embodiment will be described in detail with reference to attached figures. The lighting control system of the embodiment is adapted to control stage lighting of a lighting space 4 (such as a theater stage shown in FIG. 4). The lighting space 4 is defined, for example, as a space enclosed by a floor face 40, a back face 41, a left face 42, a right face 43, a top face 44, and a front face (which is a virtual face; not shown). In the example of FIG. 4, two or more battens 45 (two of them are shown in FIG. 4) are arranged in an top side of the stage (lighting space) 4 in parallel with each other, and lighting instruments 3 are hung from the battens 45.

The lighting instrument 3 according to the embodiment is, what is called, a moving spotlight, and is configured so that at least one of a pan angle (horizontal angle about the vertical axis), a tilt angle (vertical angle about a horizontal axis), a dimming level (amount of light), a blinking, and an irradiation area thereof can be controlled remotely. The following description will be made under a condition that the lighting instrument 3 is a moving spotlight, but the lighting instrument for stage lighting is not limited to the moving spotlight.

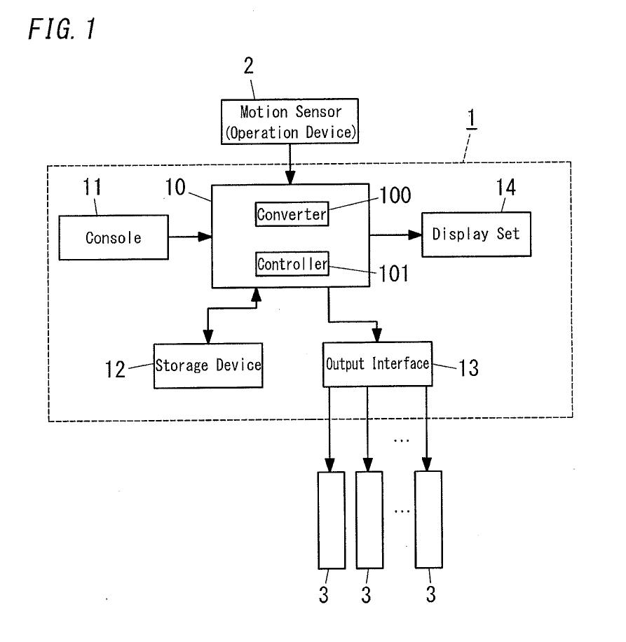

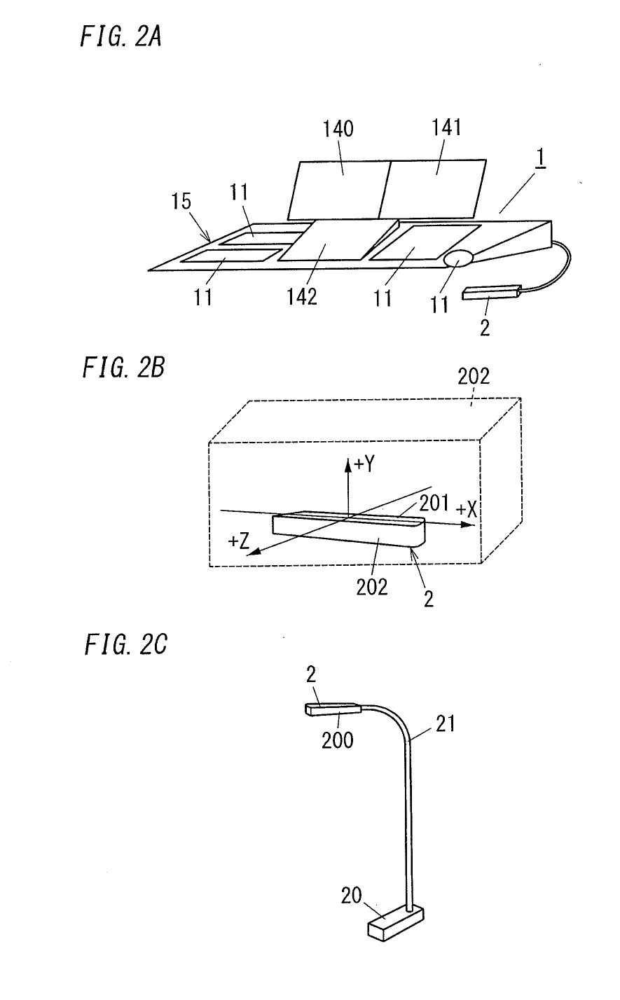

As shown in FIGS. 1 and 2A to 2C, the lighting control console of the embodiment includes a lighting console body (lighting control console main body) 1 and an operation device 2. The lighting control system of the embodiment includes the lighting control console and the lighting instruments 3.

As shown in FIG. 1, the lighting console body 1 includes a microcomputer 10, a console(s) 11, a storage device 12, an output interface 13, a display set 14, and the like.

The microcomputer 10 includes hardware such as a CPU (Central Processing Unit) and a memory, and software stored in the memory. By executing the software by the CPU, the microcomputer 10 functions as a converter 100 and/or a controller 101. The converter 100 is configured to convert a format of a signal supplied from the operation device 2 so that the controller 101 can readily process the signal. In one example, the converter 100 is configured to convert a position specified by the operation device 2 into a corresponding positional coordinate set in the lighting space 4. Here, a positional coordinate set in the lighting space 4 is represented, for example, as (u, v, w). The controller 101 is configured to control the lighting instruments 3 in accordance with the signal converted by the converter 100. Operations of the converter 100 and the controller 101 will be described later.

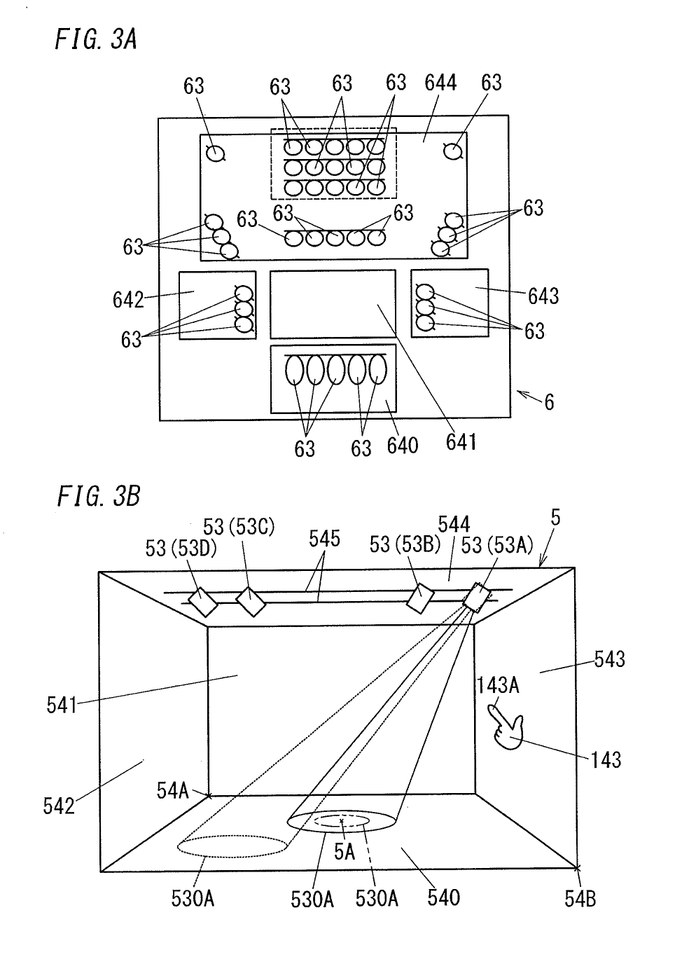

The display set 14 includes at least one display formed of a liquid crystal display or the like. In the example of FIG. 2A, the display set 14 includes three displays 140 to 142 (a first display 140, a second display 141, and a third display 142). The display set 14 is configured to display various kinds of information in accordance with control of the microcomputer 10. For example, the display set 14 is configured to display a perspective view 5 (a lighting spatial image; see FIG. 3B) of the lighting space (the stage) 4 viewed from any given direction.

In the embodiment, as shown in FIG. 2A, the first and second displays 140, 141 are arranged side by side in the back side of the lighting console body 1. The third display 142 is arranged adjacent to the console 11 in the front side of the lighting console body 1.

In the embodiment, the first display 140 is configured to display a list including names of the lighting instruments 3 and control instructions of the lighting instruments 3.

In the embodiment, the second display 141 is configured to display the lighting spatial image 5 that corresponds to the lighting space 4. As shown in FIG. 3B, the second display 141 is configured to display the perspective view (the lighting spatial image) 5 of the stage (lighting space) 4 viewed from a desired direction. In the example of FIG. 3B, the second display 141 shows the perspective view 5 of the stage 4 viewed from the front side of the stage 4. In the example of FIG. 3B, the perspective view 5 includes a virtual floor face 540, a virtual back face 541, a virtual left face 542, a virtual right face 543, and a virtual top face 544. Moreover, the second display 141 is configured to display, in the lighting spatial image (in the perspective view) 5, virtual instruments 53 that correspond to the respective lighting instruments 3. It should be noted that the second display 141 displays the virtual instrument 53 so that positions of the virtual instruments 53 in the lighting spatial image 5 correspond to respective positions of the lighting instruments 3 in the lighting space 4 (see FIGS. 3B and 4). As shown in FIG. 3B, the lighting spatial image 5 displayed on the second display 141 includes virtual battens 545 from which the virtual instruments 53 are hung.

In the embodiment, as shown in FIG. 3A, the third display 142 displays a five orthogonal views 6 of the lighting space (the stage) 4. In the example of FIG. 3A, the five orthogonal views 6 includes a floor face view 640, a back face view 641, a left face view 642, a right face view 643, and a top face view 644, which show the floor face 40, the back face 41, the left face 42, the right face 43, and the top face 44 of the stage 4, respectively. The third display 142 is configured to display, in the five orthogonal views 6, virtual instruments 63 that correspond to the respective lighting instruments 3.

For the purpose of easy viewing, FIG. 3B shows only part of the virtual instruments 53 (i.e., shows not all the virtual instruments), and FIG. 4 shows only part of the lighting instruments 3 (i.e., shows not all the lighting instruments).

Note that graphical data regarding the lighting space (the stage) 4 and the lighting instruments 3 (i.e., three dimensional information regarding coordinate system of the lighting space 4 and positional coordinate sets of the lighting instruments 3 in the lighting space 4) is stored in the storage device 12. The display set 14 is configured to display the perspective view 5 and the five orthogonal views 6 based on the graphical data (the three dimensional information) stored in the storage device 12.

The storage device 12 is formed of, for example, a rewritable non-volatile semiconductor memory such as a flash memory. The storage device 12 is configured to store “identifiers for identifying the lighting instruments 3 installed in the stage 4 (such as unique instrument numbers which are allocated to the respective lighting instruments 3)” in association with “positional information of the lighting instruments 3”. Note that the lighting instruments 3 are related to respective identifiers (e.g., respective unique instrument numbers) in advance. That is, the storage device 12 is configured to store the identifiers related to the lighting instruments 3 together with the positional information of the respective lighting instruments 3.

The console 11 includes some (many) switches (such as a push-button switch and a slide switch). The console 11 is configured to receive instructions in accordance with operations of the switches, and then supplies the microcomputer 10 with operation signals in accordance with the received instructions. The console 11 may include a touch panel(s) integrated with at least one of the displays 140 to 142 of the display set 14.

The output interface 13 is configured to convert a control signal supplied from the microcomputer 10 (the controller 101) into a control signal in conformity with a standardized communication protocol such as DMX512-A, and then supplies the control signal to a desired lighting instrument 3 via a communication cable. The lighting instruments 3 are configured so that their pan angle, tilt angle, dimming level, blinking, irradiation area and the like are remotely controlled in accordance with a control signal supplied from the output interface 13.

The operation device 2 is formed of a sensor configured to detect a position (a coordinate set in three-dimensional orthogonal coordinate system) of an operation object (an object for operating the operation device 2; a target object) in a three-dimensional space in a contactless manner.

One example of such a sensor is a range image sensor. The range image sensor includes various variations in accordance with difference in a ranging method (measuring method of distance). Examples of the range image sensor include: a Structured-Light type sensor that is configured to project a light having a predetermined 2D pattern on a target object; a light-section type sensor that is configured to scan a target object by irradiating with a slit light; and a TOF (time-of-flight) type sensor that is configured to measure a time duration from a point in time when a light is emitted to a point in time when the light comes back reflected by a target object to measure a distance. Another example, other than the range image sensor, of such a sensor is a stereo camera type sensor. The stereo camera type sensor includes, for example, two infrared cameras, and is configured to detect a position of a target object in a three-dimensional space based on images taken by the two infrared cameras just like the “triangulation method”.

In the embodiment, the operation device 2 is formed of the latter one, namely the stereo camera type sensor (a motion sensor). However, the operation device 2 may be other type of sensor such as the TOF type range image sensor.

The operation device 2 of the embodiment includes a housing 200 shaped like a box as shown in FIG. 2B, and an infrared light emitting diode(s) as a light source and two infrared cameras (image sensors) put in the housing 200. The housing 200 may be shaped like a flat rectangular parallelepiped. The operation device 2 has, in a top face thereof, a detection face 201 formed with an infrared transparent portion(s) through which the infrared of the infrared light emitting diode(s) is to pass. The operation device 2 of the embodiment includes an USB (Universal Serial Bus) interface as an interface for communication with an external device, and is to be connected to the lighting console body 1 via an USB cable (see FIG. 2A).

The operation device 2 has a detection area like a rectangular parallelepiped (cuboid) of which center of a bottom face corresponds to a center of the detection face 201 of the operation device 2, as shown by broken lines of FIG. 2B. That is, the operation device 2 has a predetermined three-dimensional detection space 202. Three-dimensional orthogonal coordinate system (X-axis, Y-axis, and Z-axis) of the detection space 202 is defined as shown in FIG. 2B, for example. Here, a positional coordinate set in the detection space 202 is represented, for example, as (x, y, z). In the example of FIG. 2B, the detection face 201 is in presence in a plane defined by the X-axis and the Z-axis. The operation device 2 is configured to take stereo images in a predetermined frame-rate (for example, in a range of several tens of frames to a hundred and several tens of frames per second), sequentially detect positional coordinate sets of an operation object (such as a finger tip) in the detection space 202, and sequentially supply the detected positional coordinate sets to the lighting console body 1.

As shown in FIG. 2A, the operation device 2 of the embodiment is designed to be used on a desk on which the lighting console body 1 is placed. However, the operation device 2 is not limited thereto. For example, the operation device 2 may be fixed to an end of a support (arm) 21 that extends upward from a base 20, as shown in FIG. 2C.

The storage device 12 preliminarily stores the graphical data for generating the lighting spatial image 5 that correspond to the lighting space 4. Note that three-dimensional coordinate system of the graphical data is related to the coordinate system (three-dimensional orthogonal coordinate system) of the lighting space 4. The storage device 12 of the embodiment also stores a relation between the coordinate system of the detection space 202 and the three-dimensional coordinate system of the graphical data for generating the lighting spatial image 5 (i.e., the coordinate system of the lighting space 4) in accordance with performing a calibration (described below). When supplied with a positional coordinate set (a positional coordinate set in the detection space 202) of an operation object from the operation device 2, the converter 100 converts the supplied positional coordinate set into a three-dimensional coordinate set in the graphical data in accordance with the relation between the coordinate system of the detection space 202 and the three-dimensional coordinate system of the graphical data stored in the storage device 12. The display set 14 (the second display 141) displays, in the lighting spatial image 5, a virtual object (an icon) 143 corresponding to the operation object in accordance with the coordinate set converted by the converter 100.

As described above, the storage device 12 stores the identifiers (such as the instrument numbers) for identifying the lighting instruments 3 installed in the lighting space (the stage) 4 and the positional information of the lighting instruments 3 in association with each other.

In an example, the storage device 12 stores the identifiers of the lighting instruments 3 in association with respective instrument coordinate sets that are positional coordinate sets in the lighting space 4 at which the respective lighting instruments 3 are installed. Here, an instrument coordinate set of a lighting instrument 3X is represented, for example, as (uX, vX, wX). For example, the storage device 12 stores the identifiers (instrument numbers) of the lighting instruments 3 in association with the respective instrument coordinate sets of the lighting instruments 3, as shown in the Table 1 below. When supplied with a positional coordinate set of the detection space 202 from the operation device 2, the converter 100 converts the supplied positional coordinate set into a positional coordinate set in the lighting space 4 in accordance with the relation between the coordinate system of the detection space 202 and the coordinate system of the lighting space 4 stored in the storage device 12. When supplied with a coordinate set associated with one of the lighting instruments 3 (i.e., when supplied with one of instrument coordinate sets) from the converter 100, the controller 101 retrieves an identifier related to the supplied instrument coordinate set from the storage device 12 and then identify a lighting instrument 3 which is related to the retrieved identifier. Note that, the “one of the lighting instruments 3” includes “at least one of the lighting instruments 3”, “an identifier” includes “at least an identifier”, and “an instrument coordinate set” includes “at least an instrument coordinate set”. That is, when supplied with at least a coordinate set associated with at least one of the lighting instruments 3 (i.e., when supplied with at least one of instrument coordinate sets) from the converter 100, the controller 101 retrieves at least an identifier related to the supplied at least one instrument coordinate set from the storage device 12 and then identify at least a lighting instrument 3 which is related to the at least one retrieved identifier.

TABLE 1

| Lighting | Identifier | |
|---|---|---|
| Instrument | (instrument | instrument |
| (see FIG. 4) | number) | coordinate set |
| 3 (3A) | xxxA | (uA, vA, wA) |
| 3 (3B) | xxxB | (uB, vB, wB) |
| 3 (3C) | xxxC | (uC, vC, wC) |
| 3 (3D) | xxxD | (uD, vD, wD) |
| . . . | . . . | . . . |

In an example, the lighting instruments 3 include at least first and second lighting instruments (3A and 3B). The first and second lighting instruments (3A and 3B) are related to first and second identifiers (xxxA and xxxB), respectively. The storage device 12 is configured to store at least the first and second identifiers (xxxA and xxxB) in association with first and second instrument coordinate sets ((uA, vA, wA) and (uB, vB, wB)), respectively. The first instrument coordinate set (uA, vA, wA) is a positional coordinate set in the lighting space 4 at which the first lighting instrument 3A is installed. The second instrument coordinate set (uB, vB, wB) is a positional coordinate set in the lighting space 4 at which the second lighting instrument 3B is installed. The controller 101 is configured: when supplied with the first instrument coordinate set (uA, vA, wA) from the converter 100, to retrieve the first identifier xxxA from the storage device 12 and then to supply a control signal to the first lighting instrument 3A related to the first identifier xxxA; and also when supplied with the second instrument coordinate set (uB, vB, wB) from the converter 100, to retrieve the second identifier xxxB from the storage device 12 and then to supply a control signal to the second lighting instrument 3B related to the second identifier.

An operation of the embodiment will now be explained.

In the following, a “preparation operation” will be explained mainly. The preparation operation is an operation for pre-storing, in the storage device 12, control instructions of the lighting instruments 3 such as dimming levels and irradiation areas thereof in line with a (theater) program performed in the stage 4.

Note that, when the program is performed, the controller 101 reads out the control instructions from the storage device 12 to generate control signals in response to an operation of a switch of the console 11, and supplies the control signals to the lighting instruments 3 via the output interface 13 to remotely control the lighting instruments 3, thereby controlling stage lighting.

Firstly, graphical data of the floor face view 640, the back face view 641, the left face view 642, the right face view 643, and the top face view 644 regarding the stage (lighting space) 4 shown in FIG. 3A is created by using CAD (Computer Aided Design). The graphical data may be created by an external device, or by the lighting console body 1 (microcomputer 10) if appropriate software is installed therein. Graphical data created by the external device may be stored in the storage device 12 of the lighting console body 1 via an interface. The graphical data also includes symbols (virtual instruments 63) that represent respective lighting instruments 3 installed in the stage 4. The controller 101 creates the perspective view 5 (see FIG. 3B) of the stage 4 using the graphical data stored in the storage device 12. The perspective view 5 also includes symbols (virtual instruments 53) that represent the respective lighting instruments 3 installed in the stage 4.

In the embodiment, the display set 14 is configured to display, on the third display 142, the five orthogonal views 6 (see FIG. 3A) read out from the storage device 12, and display, on the second display 141, the perspective view 5 created by the controller 101.

Then, performed is a calibration for mapping (correlating) the three-dimensional orthogonal system of the operation device 2 to the three-dimensional orthogonal system of the stage (the lighting space) 4 (namely, three-dimensional system of the graphical data) via the perspective view 5 displayed on the display 141. Note that, when a user puts one's fingers (operation object) inside a detection area (the detection space 202) of the operation device 2, the operation device 2 detects a positional coordinate set(s) of the finger(s), for example, a positional coordinate set of a finger tip, and supplies the positional coordinate set(s) to the controller 101. In this time, the display set 14 displays an icon (for example, an icon shaped like a human finger; a pointer) 143 in the perspective view 5 in a position specified by the operation device (see FIG. 3B).

During the calibration, the converter 100 sequentially displays a marker for any one of predetermined positions in the perspective view 5, for example, for any one of eight positions in the perspective view 5 where correspond to four corners of the floor face 40 and four corners of the top face 44 of the stage 4. In this time, the user moves one's hand (finger) inside the detection area (detection space 202) of the operation device 2, and specifies positional coordinate sets in the detection space 202 where correspond to the positions (eight positions) indicated by the marker. For example, in a case where the calibration is performed through the perspective view 5 shown in FIG. 3B, the converter 100 first displays, in the perspective view 5, a marker on an intersection 54A among the virtual floor face 540, the virtual back face 541 and the virtual left face 542. Then, the user moves one's hand to a corner of the detection space 202 defined by the negative X-axis, the negative Y-axis, and the negative Z-axis, and then associates the corner with the intersection 54A by pressing a button of the console 11. Similarly, the converter 100 displays, in the perspective view 5, a marker on an intersection 54B among the virtual floor face 540, the virtual right face 543 and a virtual front face (not shown), and then, the user moves one's hand to a corner of the detection space 202 defined by the positive X-axis, the negative Y-axis, and the positive Z-axis, and associates the corner with the intersection 54B by pressing the button of the console 11. Thereby, the detection space 202 and the lighting space 4 (the graphical data for displaying the lighting spatial image 5) are associated with each other. That is, the converter 100 makes a relation between the three-dimensional orthogonal system of the stage 4 (three-dimensional system of the graphical date) and the three-dimensional system of the operation device 2 based on each signal (positional coordinate set) supplied from the operation device 2 when a marker is specified. Thus, the calibration is finished.

Note that the calibration may be performed, for example, by entering positional coordinate sets (positional coordinate sets in the detection space 202) that correspond to the four corners of the floor face 40 and the four corners of the top face 44 of the stage 4 with a keyboard or the like, without using the operation device 2.

After completion of the calibration, when supplied with a positional coordinate set (a positional coordinate set in the three-dimensional orthogonal system of the detection space 202) from the operation device 2, the converter 100 converts the supplied positional coordinate set into a positional coordinate set in the three-dimensional orthogonal system of the stage (lighting space) 4 (i.e., in the three-dimensional system of the graphical data), and then supplies the converted positional coordinate set to the controller 101.

The creation of the graphical data and the calibration described above can be performed when the lighting control console is installed and/or after installing the lighting control console.

The preparation operation is next explained.

The controller 101 is configured to store the positional coordinate sets supplied from the converter 100 in a memory in time series. Therefore, the controller 101 is configured to detect a motion of a finger(s) using the time series positional coordinate sets stored in the memory. In other words, the operation device 2 functions not only as a pointing device for specifying a position in the detection area, but also as a motion controller for providing various instructions based on a motion of a finger.

An operation example is now explained for setting an irradiation position and an irradiation area of a (first) lighting instrument 3A.

Firstly, in the lighting spatial image 5, an user moves the icon 143 (for example, the finger tip 143A of the icon 143) to put it on a virtual instrument 53A corresponding to the desired lighting instrument 3A by moving one's finger inside the detection area of the operation device 2, thereby specifying the virtual instrument 53A corresponding to the desired lighting instrument 3A. When a switch of the console 11 is operated, the converter 100 converts the positional coordinate set in the detection space 202 specified by the icon 143 into a positional coordinate set in the lighting space 4, and to supply the positional coordinate set to the controller 101. The controller 101 searches the positional coordinate sets stored in the storage device 12 (i.e., searches the instrument coordinate sets that are positional coordinate sets of positions where the lighting instruments 3 are installed stored in the storage device 12) and picks up one that matches with the positional coordinate sets specified by the icon 143, and then acquires an identifier of the lighting instrument 3A corresponding to the virtual instrument 53A specified by the icon 143.

Then, the user moves one's finger in the detection area of the operation device 2 and to specify a desired position in the lighting spatial image 5 by means of the icon 143. For example, the user specifies a position 5A in the virtual floor face 540 of the perspective view 5 by means of the icon 143. When a switch of the console 11 is operated, the converter 100 supplies the controller 101 with a positional coordinate set in the lighting space 4 that corresponds to the position 5A specified by the icon 143. The controller 101 calculate a pan angle and a tilt angle of the lighting instrument 3A using the positional coordinate set of the position 5A supplied from the converter 100 and the positional information (positional coordinate set) of the lighting instrument 3A of which the identifier is acquired. The controller 101 then stores, in the storage device 12, the calculated pan/tilt angles in association with the identifier of the identified lighting instrument 3A. In parallel with this operation, the controller 101 changes the direction of the virtual instrument 53A (corresponding to the specified lighting instrument 3A) displayed on the display 141. For example, the controller 101 changes the direction of the virtual instrument 53A displayed on the display 141 from a direction shown by a broken line of FIG. 3B to a direction shown by a solid line when the position 5A is specified by the icon 143.

The present embodiment is also configured to enable a user to adjust an irradiation area 30A of the identified lighting instrument 3A in accordance with a pinching-in/pinching-out (for example, defined as a motion of the thumb and the forefinger of a hand moving close to/separating from each other) in the detection area of the operation device 2. For example, when detecting the pinching-in via the operation device 2 and the converter 100, the controller 101 generates a control instruction for reducing an aperture size of an iris diaphragm of the lighting instrument 3A. Similarly, when detecting the pinching-out, the controller 101 generates a control instruction for increasing the aperture size of the iris diaphragm of the lighting instrument 3A. When a switch of the console 11 is operated, the controller 101 stores, in the storage device 12, the control instruction for indicating an aperture size of the iris diaphragm in association with the identifier of the identified lighting instrument 3A. In parallel with this operation, the controller 101 changes (reduces and expands) the virtual irradiation area 530A displayed in the perspective view 5 in accordance with the pinching-in and the pinching-out. For example, the controller 101 reduces the virtual irradiation area 530A displayed in the perspective view 5 from an area shown by a solid line of FIG. 3B to an area shown by a two-dot chain line in accordance with the pinching-in.

In a case where the lighting instrument 3 includes a gobo-wheel or a color-wheel, the present embodiment may be configured to enable a user to rotate the gobo-wheel or the color-wheel of the lighting instrument 3 to select a desired gobo or color filter in accordance with a rotation of a finger(s) in the detection area of the operation device 2. The gobo-wheel is formed of, for example, a circular plate provided with two or more gobos (patterns) that are arranged along the circumference of the plate. Therefore, when a certain gobo is selected (a certain gobo is placed between a lamp and e.g., a floor face), the gobo (pattern) is to be projected on the floor face. The color-wheel is formed of, for example, a circular plate provided with two or more color filters that are arranged along the circumference of the plate and are configured to change the color of the lighting instrument 3. The gobo-wheel is provided with a rotation mechanism with a motor, and is configured to rotate in accordance with an operation of the rotation mechanism driven by the motor. Similarly, the color-wheel is provided with a rotation mechanism with a motor, and is configured to rotate in accordance with an operation of the rotation mechanism driven by the motor.

For example, when the user moves one's finger inside the detection area of the operation device 2 so that the finger tip describes an arc with a predetermined angle (e.g., 90°) or more, the controller 101 detects “a rotation of finger”. The controller 101 rotates the wheel a prescribed angle in the circumferential direction of the wheel per a detection of the rotation of finger, to thereby change the current filter to a new filter which is next to the current filter. For example, in a case where the wheel is provided with four filters along the circumferential direction thereof at equal spaces, the controller 101 rotates the wheel 90° in order to change the current filter to the next filter per a detection of the rotation of finger.

Alternatively, the controller 101 may rotate the wheel in accordance with a rotation angle of a finger. For example, in a case where the wheel is provided with four filters along the circumferential direction thereof at equal spaces, the controller 101 may: keep the current filter when detecting a rotation of finger in a range of 0° to 90°; rotate the wheel 90° to change the current filter to the next filter when detecting a rotation of finger in a range of 90° to 180°; rotate the wheel 180° to change to the second filter away from the current filter when detecting a rotation of finger in a range of 180° to 270°; and rotate the wheel 270° to change to the third filter away from the current filter when detecting a rotation of finger in a range of 270° to 360°, or the like.

Then, the controller 101 stores, in the storage device 12, the control instruction for selecting the gobo or color filter in association with the identifier of the identified lighting instrument 3A.

The controller 101 may also be configured to rotate a current filter (without rotating the wheel) in accordance with a motion of the operation object in the detection area of the operation device 2. Gobo filters of a lighting instrument 3 typically have not-circular apertures (for example, “Cathedral Spikes”, “Galaxy Breakup”, and the like). Therefore, the shape of the light emitted from the lighting instrument 3 can be changed by rotating the gobo filter. For example, when detecting a rotation of five fingers around a predetermined axis (e.g., around an axis of the arm), the controller 101 rotates the current filter in accordance with the rotation angle of the hand (or in accordance with a detection of rotation of hand).

In a case where the lighting instrument 3 is a moving spotlight, the controller 101 of the present embodiment may be configured to enable a user to change an irradiation direction and/or an irradiation area of the identified lighting instrument 3 in accordance with a track of a movement of a user's finger in the detection area of the operation device 2. Then, the controller 101 stores, in the storage device 12, the moving track as the control instruction for the irradiation direction and/or the irradiation area of the identified lighting instrument 3 in association with the identifier of the identified lighting instrument 3.

After the preparation operation as described above, the control instructions of the lighting instruments 3 are stored in the storage device 12 of the lighting console body 1 together with the identifiers of the lighting instruments 3 in a table format. The controller 101 is configured to read out the control instructions together with the identifiers, and then displays, on the display 140 of the display set 14, the relation between the control instructions and related lighting instruments 3 in a table form in response to a certain operation signal supplied from the console 11.

Additionally, the controller 101 is configured to simulate (e.g., is installed therein software for simulating) the control instructions stored in the storage device 12. In detail, the controller 101 is configured, through the three-dimensional computer graphics (3DCG), to create a video image (hereinafter, referred to as “3DCG video image”) that simulates the stage 4 from the graphical data (prepared by the CAD), and to display the 3DCG video image on the display 141 of the display set 14. During this operation, the controller 101 sequentially reads out the control instructions stored in the storage device 12, and sequentially creates (updates) the 3DCG image to be displayed on the display 141 in accordance with the retrieved control instructions to simulate the actual operations of the lighting instruments 3. It is therefore possible for a user to confirm the control instructions for the lighting instruments 3 while observing the 3DCG video image displayed on the display 141.

It is preferable that viewpoint of the perspective view 5 can be changed in the preparation operation and/or in displaying the 3DCG video image. For example, the controller 101 may be configured, when receiving a signal for specifying a point in the detection space 202 from the operation device 2, to create a perspective view 5 of the stage 4 viewed from a point in the lighting space 4 that corresponds to the specified point in the detection space 202, and to display the created view on the display 141.

The controller 101 may further have a function for specifying a target lighting instrument 3 without using the operation device 2, in addition to the function for specifying a target lighting instrument 3 with the operation device 2. For example, in a case where the display 140 has a touch panel, the controller 101 may be configured to specify a lighting instrument 3 as the target lighting instrument when a name of the lighting instrument 3 listed in the display 140 is selected through the touch panel. For example, in a case where the display 141 has a touch panel, the controller 101 may be configured to specify a lighting instrument 3 as the target lighting instrument when a virtual instrument 53 corresponding to the lighting instrument 3 displayed on the display 141 is selected through the touch panel. For example, in a case where the console 11 has a keyboard, the target lighting instrument may be specified in response to typing of an identifier (an instrument number) of a lighting instrument 3 through the keyboard.

The target lighting instrument 3 that has been specified not through the operation device 2 also can be set its operation through the operation device 2 in accordance with a motion of the operation object detected through the operation device 2.

When a (theater) program is performed in the stage 4 or when the lighting instruments 3 are actually operated during the preparation operation, the controller 101 sequentially retrieves, from the control instructions stored in the storage device 12, a control instruction in accordance with an operation signal supplied from the console 11. Then, the controller 101 generates a control signal corresponding to the retrieved control instruction to supply the control signal to the lighting instrument 3 through the output interface 13. The lighting instruments 3 are remotely controlled their pan/tilt angles, dimming levels, blinking, irradiation areas in accordance with the control signal(s) supplied through the output interface 13. As a result, the stage lighting can be controlled according to the program performed in the stage 4.

As described above, the lighting control console of the embodiment is designed to control the lighting instruments 3 installed in the lighting space 4 such as a stage and a studio in order to control stage lighting. The lighting control console of the embodiment includes: the display set 14 (the second display 141) configured to display the perspective view 5 of the lighting space 4 viewed from a desired direction; the operation device 2 configured to specify a position in the perspective view 5; and the converter 100 configured to convert the position specified by the operation device 2 into a positional coordinate set in the lighting space 4. The lighting control console of the embodiment further includes the storage device 12 configured to store the identifiers for identifying the lighting instruments 3 in association with respective positional coordinate sets at which the respective lighting instruments 3 are installed. The lighting control console further includes the controller 101 configured to retrieve, from the storage device 12, an identifier that corresponds to a positional coordinate set converted by the converter 100, and to supply a control signal to a lighting instrument 3 that has the retrieved identifier. The operation device 2 is configured to detect a position of an operation object in a three-dimensional space (the detection space 202) to specify the position in the perspective view 5.

According to the lighting control console of the embodiment, a position in the perspective view 5 of the lighting space 4 is specified in accordance with a position of the operation object (such as a finger) detected through the operation device 2. It is therefore possible to improve the workability of operation (such as a selecting operation of a lighting instrument 3) in comparison with the conventional example that uses the touch panel. That is, according to a two-dimensional space in the conventional example displayed on a display screen, the touch panel has a poor resolution in the depth direction in comparison with those in the height and width directions. On the contrary, the present embodiment is configured to convert a positional coordinate set in the three-dimensional space 202 specified through the operation device 2 into a positional coordinate set in the actual lighting space (the stage) 4. Accordingly, the present embodiment can finely specify a position in the depth direction in comparison with the conventional example using the touch panel. The lighting control console of the embodiment can therefore improve the workability of operation (such as a selecting operation of a lighting instrument 3) in comparison with the conventional example with the touch panel.

Because the operation device 2 is configured to use a human finger as the operation object, the embodiment can have an improved workability in comparison with a case where another tool is used as the operation object.

Preferably, the operation device 2 has a housing 200 shaped like a box, and is configured to detect a position of the operation device in the three-dimensional space 202 which is a space within a predetermined range from the housing 200.

Preferably, the operation device 2 is configured to detect a motion of the operation object. Preferably, the controller 101 is configured to supply a control signal for controlling at least one of the irradiation direction of the lighting instrument 3, the light amount of the lighting instrument 3, and the blinking of the lighting instrument 3 in accordance with a motion of the operation object detected through the operation device 2. The operation device 2 and the controller 101 having this configuration enable a user to enter a control instruction of a lighting instrument 3 through a motion of one's fingers (such as pinching-in and pinching-out), and therefore can improve the workability.

Preferably, the controller 101 is configured to display, on the display set 14 (the second display 141), a perspective view 5 viewed from a position specified through the operation device 2. For example, when a user rotate one's finger (e.g., about the vertical axis) in the detection area (detection space 202) of the operation device 2, the controller 101 creates a perspective view viewed from a changed viewpoint and then display it on the display set 14. This configuration enables the user to see the stage 4 viewed from another direction, and therefore can improve the workability.

Described in other words, the lighting control console of the present embodiment is configured to control the lighting instruments 3 installed in the lighting space 4 in order to control stage lighting. The lighting control console of the embodiment includes the display 141, the operation device 2, and the controller 101. The display 141 is configured to display the lighting spatial image 5 corresponding to the lighting space 4, and to display, in the lighting spatial image 5, the virtual instruments 53 which correspond to the respective lighting instruments 3 so that positions of the virtual instruments 53 in the lighting spatial image 5 correspond to respective positions of the lighting instruments 3 in the lighting space 4. The operation device 2 has the three dimensional detection space 202 associated with at least one of the lighting spatial image 5 and the lighting space 4. The operation device 2 is configured to detect a position of the operation object in the detection space 202 and to specify a position in the lighting spatial image 5 based on the detected position in the detection space 202. That is, the operation device 2 is configured to detect a position of the operation object in the detection space 202, and to specify a position in the lighting spatial image 5 that corresponds to the detected position in the detection space 202. The controller 101 is configured, when (at least) one of the virtual instruments 53 in the lighting spatial image 5 is specified by the operation object through the operation device 2, to identify (at least) a lighting instrument 3 associated with the (at least one) specified virtual instrument 53.

According to the lighting control console of the embodiment, the operation device 2 has the three-dimensional detection space 202 and is configured to identify a lighting instrument 3 in accordance with a detected position of the operation object in the detection space 202. Therefore, the present embodiment can finely specify a position in the depth direction in comparison with the conventional example using a touch panel.

In one embodiment, the lighting instruments 3 are related to respective identifiers. The lighting control console further includes the converter 100 and the storage device 12. The converter 100 is configured to convert (at least) a position in the lighting spatial image 5 specified by the operation object through the operation device 2 into (at least) a positional coordinate set in the lighting space 4. The storage device 12 is configured to store the identifiers in association with respective instrument coordinate sets. The instrument coordinate sets are positional coordinate sets in the lighting space 4 at which the respective lighting instruments 3 are installed. The controller 101 is configured, when supplied with (at least) one of the instrument coordinate sets from the converter 100, to retrieve, from the storage device, (at least) an identifier related to the (at least one) supplied instrument coordinate set and then to supply (at least) a control signal to (at least) a lighting instrument which is related to the (at least one) retrieved identifier.

According to this configuration, the converter 100 is configured to convert a position in the lighting spatial image 5 specified by the operation object through the operation device 2 into a positional coordinate set in the lighting space 4, thereby converting the information (regarding positional coordinate set in the detection space 202) supplied to the microcomputer 10 from the operation device 2 into manageable data (e.g., positional coordinate set in the lighting space 4). It is therefore possible to improve the processing efficiency of the microcomputer 10.

In one embodiment, the operation object for the operation device 2 is a human finger(s). This configuration can improve the workability.

In one embodiment, the operation device 2 has the housing 200 shaped like a box. The detection space 202 is a space within a predetermined range from the housing 200.

In one embodiment, the operation device 2 is configured to detect a motion of the operation object. The controller 101 is configured to supply the identified lighting instrument 3 with a control signal for controlling at least one of irradiation direction of light, amount of light, and blinking of the lighting instrument 3 in accordance with the motion of the operation object detect by the operation device 2.

In one embodiment, the controller 101 is configured to cause the display set 14 (the display 141) to display a lighting spatial image (perspective view) 5 viewed from a direction specified by the operation object through the operation device 2.

In one embodiment, the lighting spatial image 5 is a perspective projection view.

In one embodiment, the lighting spatial image 5 is a three dimensional image.

In the embodiment described above, the storage device 12 is configured to store the identifiers of the lighting instruments 3 in association with the respective instrument coordinate sets (i.e., positional coordinate sets in the lighting space 4 at which the respective lighting instruments 3 are installed), but the embodiment is not limited thereto. For example, in another configuration, the storage device 12 is configured to store the identifiers of the lighting instruments 3 in association with respective virtual instrument coordinate sets. The virtual instrument coordinate sets are positional coordinate sets in the detection space 202 and are associated with positions in the lighting space (the stage) 4 at which the respective lighting instruments 3 are installed. Here, a virtual instrument coordinate set corresponding to a lighting instrument 3X is represented, for example, as (xX, yX, zX). For example, the storage device 12 stores the identifiers (instrument numbers) of the lighting instruments 3 in association with the respective virtual instrument coordinate sets of the virtual instruments 53 corresponding to the respective lighting instruments 3, as shown in the Table 2 below.

TABLE 2

| | corresponding | | |
|---|---|---|---|
| Lighting | virtual | Identifier | virtual |
| Instrument | instruments | (instrument | instrument |
| (see FIG. 4) | (see FIG. 3B) | number) | coordinate set |
| 3 (3A) | 53 (53A) | xxxA | (xA, yA, zA) |
| 3 (3B) | 53 (53B) | xxxB | (xB, yB, zB) |
| 3 (3C) | 53 (53C) | xxxC | (xC, yC, zC) |
| 3 (3D) | 53 (53D) | xxxD | (xD, yD, zD) |
| . . . | . . . | . . . | . . . |

In this another configuration, the storage device 12 makes relations between identifiers of the lighting instruments 3 and positional coordinate sets in the detection space 202 when performing the calibration to make association between the three-dimensional coordinate system of the graphical data and coordinate system of the detection space 202. In this configuration, the display set 14 (the display 141) may be configured to display the virtual instruments 53 in the lighting spatial image 5 in accordance with the virtual instrument coordinate sets (the positional coordinate sets in the detection space 202 stored in the storage device 12). The controller 101 may be configured, when supplied with (at least) one of the virtual instrument coordinate sets, to retrieve (at least) an identifier associated with the (at least one) supplied virtual instrument coordinate set from the storage device 12 and then to supply (at least) a control signal to (at least) a lighting instrument 3 which is related to the (at least one) retrieved identifier.

That is, in one embodiment, the lighting instruments 3 are related to respective identifiers. The lighting control console further includes the storage device 12. The storage device 12 is configured to store identifiers in association with respective virtual instrument coordinate sets that are positional coordinate sets in the detection space 202 and that are associated with positions in the lighting space 4 at which the respective lighting instruments 3 are installed. The display set 14 (the second display 141) is configured to display the virtual instruments 53 in the lighting spatial image 5 in accordance with the virtual instrument coordinate sets. The controller 101 is configured, when supplied with (at least) one of the virtual instrument coordinate sets from the operation device 2, to retrieve, from the storage device 12, (at least) an identifier associated with the (at least one) supplied virtual instrument coordinate set and then to supply (at least) a control signal to (at least) a lighting instrument 3 which is related to the (at least one) retrieved identifier.

According to this another configuration, the microcomputer 10 processes the information itself (positional coordinate set in the detection space 202) supplied from the operation device 2 in order to control the lighting instruments 3. It is therefore possible to improve the processing efficiency of the lighting control console.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A lighting control console configured to control lighting instruments installed in a lighting space in order to control stage lighting, comprising:
a display configured to display a lighting spatial image corresponding to the lighting space, and to display, in the lighting spatial image, virtual instruments which correspond to the respective lighting instruments so that positions of the virtual instruments in the lighting spatial image correspond to respective positions of the lighting instruments in the lighting space;
an operation device which has a three dimensional detection space associated with at least one of the lighting spatial image and the lighting space, and is configured to detect a position of an operation object in the detection space and to specify a position in the lighting spatial image based on the detected position in the detection space; and
a controller configured, when one of the virtual instruments in the lighting spatial image is specified by the operation object through the operation device, to identify a lighting instrument associated with the specified virtual instrument.

2. The lighting control console according to claim 1, wherein
the lighting instruments are related to respective identifiers,
the lighting control console further comprises:
a converter configured to convert a position in the lighting spatial image specified by the operation object through the operation device into a positional coordinate set in the lighting space; and
a storage device configured to store the identifiers in association with respective instrument coordinate sets that are positional coordinate sets in the lighting space at which the respective lighting instruments are installed, and
the controller is configured, when supplied with one of the instrument coordinate sets from the converter, to retrieve, from the storage device, an identifier related to the supplied instrument coordinate set and then to supply a control signal to a lighting instrument which is related to the retrieved identifier.

3. The lighting control console according to claim 2, wherein
the lighting instruments include at least first and second lighting instruments, said first and second lighting instruments being related to first and second identifiers, respectively,
the storage device is configured to store at least the first and second identifiers in association with first and second instrument coordinate sets, respectively, said first instrument coordinate set being a positional coordinate set in the lighting space at which the first lighting instrument is installed, said second instrument coordinate set being a positional coordinate set in the lighting space at which the second lighting instrument is installed, and
the controller is configured: when supplied with the first instrument coordinate set from the converter, to retrieve the first identifier from the storage device and then to supply a control signal to the first lighting instrument related to the first identifier; and also when supplied with the second instrument coordinate set from the converter, to retrieve the second identifier from the storage device and then to supply a control signal to the second lighting instrument related to the second identifier.

4. The lighting control console according to claim 1, wherein
the lighting instruments are related to respective identifiers, and
the lighting control console further comprises a storage device configured to store identifiers in association with respective virtual instrument coordinate sets, said virtual instrument coordinate sets being positional coordinate sets in the detection space and associated with positions in the lighting space at which the respective lighting instruments are installed.

5. The lighting control console according to claim 4, wherein the display is configured to display the virtual instruments in the lighting spatial image in accordance with the virtual instrument coordinate sets.

6. The lighting control console according to claim 4, wherein the controller is configured, when supplied with one of the virtual instrument coordinate sets, to retrieve, from the storage device, an identifier associated with the supplied virtual instrument coordinate set and then to supply a control signal to a lighting instrument which is related to the retrieved identifier.

7. The lighting control console according to claim 1, wherein the operation object for the operation device is a human finger.

8. The lighting control console according to claim 1, wherein
the operation device has a housing shaped like a box, and
the detection space is a space within a predetermined range from the housing.

9. The lighting control console according to claim 1, wherein
the operation device is configured to further detect a motion of the operation object, and
the controller is configured to supply the identified lighting instrument with a control signal for controlling at least one of irradiation direction of light, amount of light, and blinking of the lighting instrument in accordance with the motion of the operation object detect by the operation device.

10. The lighting control console according to claim 1, wherein the controller is configured to cause the display to display a lighting spatial image viewed from a direction specified by the operation object through the operation device.

11. The lighting control console according to claim 1, wherein the lighting spatial image is a perspective projection view.

12. The lighting control console according to claim 1, wherein the lighting spatial image is a three dimensional image.

13. A lighting control system comprising:
lighting instruments installed in a lighting space, and
a lighting control console configured to control the lighting instruments in order to control stage lighting, wherein
the lighting control console comprises:
a display configured to display a lighting spatial image corresponding to the lighting space, and to display, in the lighting spatial image, virtual instruments which correspond to the respective lighting instruments so that positions of the virtual instruments in the lighting spatial image correspond to respective positions of the lighting instruments in the lighting space,
an operation device which has a three dimensional detection space associated with at least one of the lighting spatial image and the lighting space, and is configured to detect a position of an operation object in the detection space and to specify a position in the lighting spatial image based on the detected position in the detection space, and
a controller configured, when one of the virtual instruments in the lighting spatial image is specified by the operation object through the operation device, to identify a lighting instrument associated with the specified virtual instrument.
